(19) United States
(12) Patent Application Publication
(10) Pub. No.: US 2015/0117688 A1
(43) Pub. Date: Apr. 30, 2015

(54) HYBRID HEARING DEVICE

(71) Applicant: Samsung Electronics Co., Ltd., Suwon-si (KR)

(72) Inventors: Sang Wook KIM, Seoul (KR); See Youn KWON, Seoul (KR); Dong Wook KIM, Seoul (KR)

(73) Assignee: SAMSUNG ELECTRONICS CO., LTD., Suwon-si (KR)

(21) Appl. No.: 14/204,271

(22) Filed: Mar. 11, 2014

(30) Foreign Application Priority Data
Oct. 31, 2013 (KR) 10-2013-0131057

(51) Int. Cl. H04R 1/10; H04R 25/00

(52) U.S. Cl. CPC H04R 1/10; H04R 25/43; H04R 2225/025; H04R 2225/67
USPC 381/321

(57) ABSTRACT

A hearing device is disclosed, wherein the hearing device may include an audio signal detector configured to detect an audio signal, an output signal generator configured to generate an output signal by adjusting an amplifying gain of the audio signal, a controller configured to determine an output method for the output signal to be one of a bone conduction method or an air conduction method, and an output unit configured to output the output signal.

### RELATED APPLICATIONS

This application claims the benefit under 35 USC 119(a) of Korean Patent Application No. 10-2013-0131057, filed on Oct. 31, 2013, in the Korean Intellectual Property Office, the entire disclosure of which is hereby incorporated by reference for all purposes.

### BACKGROUND

1. Field

The following description relates to a hybrid hearing device.

2. Description of Related Art

A hearing device aids a user wearing the hearing device to hear sounds generated around the user. The hearing device receives a sound wave through a microphone. The hearing device converts, amplifies, and outputs the received sound wave. With the developments of an integrated circuit (IC) and hearing device fitting technology, the hearing device is now capable of providing a gain and an output appropriate for a type and a degree of hearing loss. Also, a size of the hearing device has been reduced. The hearing device is produced in various forms including a type to be mounted onto a glasses frame, a behind-the-ear (BTE) type to be worn on an ear, and an in-ear type to be worn inside an ear. Research is being conducted to deliver a clearer sound to the user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a hearing device including an audio signal detector configured to detect an audio signal, an output signal generator configured to generate an output signal by adjusting an amplifying gain of the audio signal, a controller configured to determine an output method for the output signal to be one of a bone conduction method or an air conduction method, and an output unit configured to output the output signal.

The controller may be configured to determine the output method based on a frequency band of the audio signal.

In response to the frequency band of the audio signal being less than or equal to a critical frequency band, the controller may be configured to determine the output method to be the bone conduction method, and in response to the frequency band of the audio signal being greater than the critical frequency band, the controller may be configured to determine the output method to be the air conduction method.

The device may include a low pass filter configured to allow audio signal having the frequency band less than or equal to a critical frequency band, a high pass filter configured to allow audio signal having the frequency band greater than the critical frequency band, and wherein the controller is configured to determine the output method to be the bone conduction method in response to the audio signal having passed through the low pass filter, and to determine the output method to be the air conduction method in response to the audio signal having passed through the high pass filter.

The output unit may include a bone conduction receiver configured to output the output signal based on the bone conduction method, and an air conduction receiver configured to output the output signal based on the air conduction method.

The bone conduction receiver may include an oscillator configured to output the output signal through vibrating, a vent configured to vent air present in an ear, a protector disposed at a center of the bone conduction receiver, and the air conduction receiver being disposed in the protector.

The hearing device may be provided as an in-ear type hearing device, and further include a housing inserted in an ear.

The hearing device may be provided as a behind-the-ear type (BTE) hearing device, and further include a first housing disposed around an ear, and a second housing inserted in the ear, and wherein the output unit is disposed in the second housing.

The amplifying gain may be based on an audiogram reflecting a hearing characteristic of a user.

The controller may be configured to determine the output method to be the bone conduction method in response to the audio signal having passed through the low pass filter and the audio signal having passed through the high pass filter being combined.

In another general aspect, there is provided an operation method of a hearing device, the method including detecting an audio signal, generating an output signal by adjusting an amplifying gain of the audio signal, determining an output method for the output signal to be one of a bone conduction method or an air conduction method, and outputting the output signal using the determined output method.

The determining may include determining the output method based on a frequency band of the audio signal.

The determining may include determining the output method to be the bone conduction method in response to the frequency band of the audio signal being less than or equal to a critical frequency band, and determining the output method to be the air conduction method in response to the frequency band of the audio signal being greater than the critical frequency band.

The determining may include determining the output method to be the bone conduction method in response to an audio signal having passed through a low pass filter, the low pass filter being configured to allow the audio signal having the frequency band less than or equal to a critical frequency band, and determining the output method to be the air conduction method in response to an audio signal having passed through a high pass filter, the high pass filter being configured to allow the audio signal having the frequency band greater than a critical frequency band.

The outputting may include outputting the output signal using a bone conduction receiver in response to the determined output method being the bone conduction method, and outputting the output signal using an air conduction receiver in response to the determined output method being the air conduction method.

The bone conduction receiver may include an oscillator configured to output the output signal through vibrating, a vent configured to vent air present in an ear, a protector disposed at a center of the bone conduction receiver, and the air conduction receiver being disposed in the protector.

The amplifying gain may be based on an audiogram reflecting a hearing characteristic of a user wearing the hearing device.

In another general aspect, there is provided a hearing device including a housing comprising an audio signal detector, an output signal generator, a controller, and a an output unit, and the controller is configured to determine whether to convey an output audio signal to auditory nerve via transmitting vibrations corresponding to the output audio signal to a bone or via transmitting the output audio signal through air.

The audio signal detector may be disposed at a first end of the housing and the output unit may be disposed at a second end of the housing, and wherein the output unit may include an oscillator disposed proximal to a bone of a user, a vent configured to vent air present in an ear of the user, a protector disposed near a center of the output unit, and an air conduction receiver being disposed in the protector and proximal to the eardrum of the user.

The output signal generator may be configured to generate the output audio signal by adjusting an amplifying gain of an audio signal and the amplifying gain is based on an audiogram reflecting a hearing characteristic of a user, and the hearing device further comprises a storage configured to store the audiogram.

Other features and aspects will be apparent from the following detailed description, the drawings, and the claims.

### BRIEF DESCRIPTION OF THE DRAWINGS

FIG. 1 is a diagram illustrating an example of a hybrid hearing device.

FIG. 2 is a diagram illustrating an example of determining an output method.

FIG. 3 is a diagram illustrating an example of a frequency characteristic of an audio signal.

FIGS. 4A and 4B are diagrams illustrating examples of an in-ear type hybrid hearing device.

FIG. 5 is a diagram illustrating a behind-the-ear (BTE) type hybrid hearing device.

FIG. 6 is a diagram illustrating an example of an operation method of a hybrid hearing device.

Throughout the drawings and the detailed description, unless otherwise described, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

In the following description, a hearing device may refer to an apparatus capable of providing an audio signal to a user by being removabely attached to or in close contact with the user's ear. The hearing device may include a hearing aid that amplifies an audio signal generated from an external source and aids the user in perceiving the audio signal. The hearing device may include or be included in a system supporting a hearing aid function. Such a system may include, but is not limited to, a mobile device, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a television (TV), a high definition television (HDTV), an optical disc player, a DVD player, a Blue-ray player, a setup box, any other, consumer electronics/information technology (CE/IT) device, a plug-in accessory or a hearing aid module having a sound or broadcasting relay function for a hearing aid, and a hearing aid chip.

The hearing device includes a monaural device generating an audio signal for an ear and a binaural device generating an audio signal for both ears.

In an example, a hearing device disclosed herein may operate in a general mode or a hybrid mode. The general mode refers to an operation mode in which the hearing device performs a general function, for example, an operation of a general hearing aid. The hybrid mode refers to an operation mode in which the hearing device controls an output method for an output signal to be one of a bone conduction method or an air conduction method based on an audio signal. Hereinafter, a hybrid hearing device performing functions of the hybrid mode will be described.

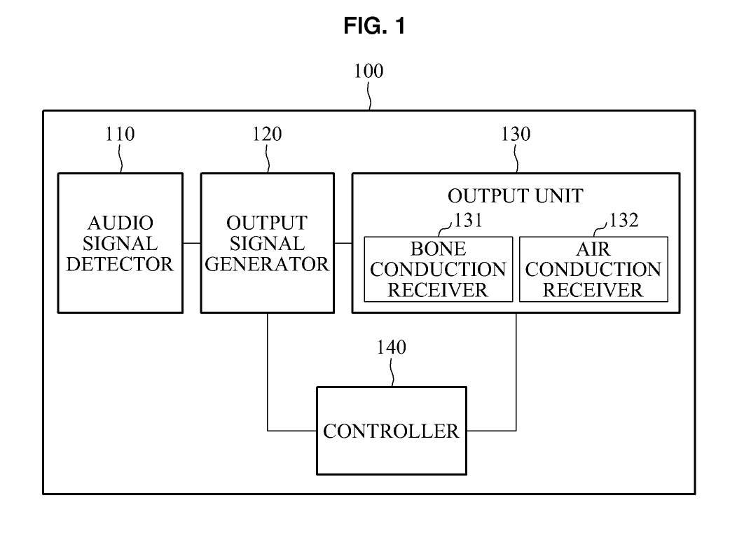

FIG. 1 is a block diagram illustrating an example of a hybrid hearing device 100.

Referring to FIG. 1, the hybrid hearing device 100 may include an audio signal detector 110, an output signal generator 120, an output unit 130, and a controller 140. In a non-exhaustive example, the output signal generator 120 and the controller 140 may be provided in a processor.

The audio signal detector 110 may detect an audio signal. The audio signal detector 110 may include at least one microphone and may detect the audio signal using the microphone. The audio signal may denote all signals detectable from an external source through the microphone, including a voice signal. In an example, a frequency band of the detected audio signal may be a frequency band audible to human beings, which ranges from about 20 hertz (Hz) to about 20 kilohertz (KHz).

The output signal generator 120 may generate an output signal by adjusting an amplifying gain based on the audio signal. In an example, the output signal generator 120 may convert the detected audio signal from an analog signal to a digital signal, and perform digital signal processing on the converted audio signal. The output signal generator 120 may amplify the audio signal on which the digital signal processing is performed based on the amplifying gain, and generate the output signal by converting the amplified audio signal from a digital signal to an analog signal.

The amplifying gain may be determined based on an audiogram reflecting a hearing characteristic of a user wearing the hybrid hearing device 100. The audiogram refers to a graph representing a hearing threshold in each frequency band from a low pitched sound to a high pitched sound. The hearing threshold refers to a lowest sound audible to a listener. The vertical axis of the audiogram indicates sound intensity measured in decibels (dB) and the horizontal axis of the audiogram indicates a sound frequency band. In a non-exhaustive example, the audiogram may be generated based on audiometry conducted with respect to the user. The hybrid hearing device 100 may include a storage (not shown) and the audiogram may be stored in the storage. The hybrid hearing device 100 may perform calibration to amplify the output signal to be suitable for the user based on the stored audiogram. A result value obtained by the calibration may also be stored in the storage. The hybrid hearing device 100 may generate the output signal by adjusting the amplifying gain based on the result value.

The controller 140 may determine an output method for the output signal to be one of a bone conduction method and an air conduction method based on the audio signal. When the output method is determined to be the bone conduction method, the hybrid hearing device 100 may output the output signal using a bone conduction receiver 131. When the output method is determined to be the air conduction method, the hybrid hearing device 100 may output the output signal using an air conduction receiver 132.

The controller 140 may determine the output method based on a frequency band of the audio signal. The bone conduction receiver 131 may forward, to the user, an audio signal having a low frequency band while maintaining a low frequency response characteristic of the audio signal having the low frequency band. However, the frequency band of the audio signal forwardable by the bone conduction receiver 131 may be narrow. The air conduction receiver 132 may forward, to the user, an audio signal having a broad frequency band. When the air conduction receiver 132 forwards a low frequency audio signal, a low frequency response characteristic of the audio signal may be lost. Thus, due to the controller 140 determining the output method based on the frequency band of the audio signal, the audio signal having the broad frequency band may be forwarded to the user while the low frequency response characteristic of the audio signal may be maintained.

For example, when the frequency band of the audio signal is less than or equal to a critical frequency band, the controller 140 may determine the output method to be the bone conduction method. When the frequency band of the audio signal is greater than the critical frequency band, the controller 140 may determine the output method to be the air conduction method. In a non-exhaustive example, the critical frequency band may be 4000 Hz. When an audio signal having a frequency band less than or equal to 4000 Hz is output using the air conduction method, the low frequency response characteristic may be lost. To maintain the low frequency response characteristic, the controller 140 may determine the output method to be the bone conduction method for an output signal generated based on the audio signal having the frequency band less than or equal to 4000 Hz. Due to the bone conduction method forwarding only the audio signal having a narrow band, an output signal generated based on the audio signal having a frequency band greater than 4000 Hz may not be output through the bone conduction method. Thus, the controller 140 may determine the output method to be the air conduction method for the output signal generated based on the audio signal having the frequency band greater than 4000 Hz.

In an example, the hybrid hearing device 100 may include a low pass filter (LPF) (no shown) and a high pass filter (HPF) (not shown). The LPF may allow the audio signal having the frequency band less than or equal to the critical frequency band to pass, and the HPF may allow only the audio signal having the frequency band greater than the critical frequency band to pass. The controller 140 may determine the output method to be the bone conduction method for the output signal generated based on the audio signal having passed through the LPF. Also, the controller 140 may determine the output method to be the air conduction method for the output signal generated based on the audio signal having passed through the HPF.

The output unit 130 may output the output signal using the determined output method. The output unit 130 may include the bone conduction receiver 131 to output the output signal using the bone conduction method, and the air conduction receiver 132 to output the output signal using the air conduction method. The output signal output from the air conduction receiver 132 may be forwarded to an auditory nerve of the user through an eardrum.

The bone conduction receiver 131 may output the output signal through vibrating. The output signal from the bone conduction receiver 131 may be forwarded to the auditory nerve of the user through a bone of the user, for example, through a cranium of the user. In an example, when the user wears the hybrid hearing device 100, the bone conduction receiver 131 may be positioned around the eardrum of the user. Also, the bone conduction receiver 131 may include an oscillator to output the output signal through vibrating, a vent to vent the air present in an ear of the user, and a protector disposed at the center of the bone conduction receiver 131. In an example, the oscillator may output the output signal using a bone conduction transducer. The vent may reduce an air pressure difference between atmosphere and an outer ear and reduce the wearer's discomfort by circulating the air. The protector may be disposed at the center of the bone conduction receiver 131 and could maintain the shape of the bone conduction receiver 131.

The air conduction receiver 132 may be disposed in the protector of the bone conduction receiver 131. When the user wears the hybrid hearing device 100, the bone conduction receiver 131 may be disposed near the bone of the user and the air conduction receiver 132 may be disposed near the eardrum of the user.

In a non-exhaustive example, the hybrid hearing device 100 may be provided in a form of an in-ear type hearing device. The hybrid hearing device 100 may include a housing inserted in the ear. In this case, the housing may include the signal detector 110, the output signal generator 120, the output unit 130, and the controller 140.

In another example, the hybrid hearing device 100 may be provided in a form of a behind-the-ear (BTE) type hearing device. The hybrid hearing device 100 may include a first housing disposed around the ear and a second housing inserted in the ear. The first housing may include the audio signal detector 110, the output signal generator 120, and the controller 140. The second housing may include the output unit 130 and be inserted in the ear of the user.

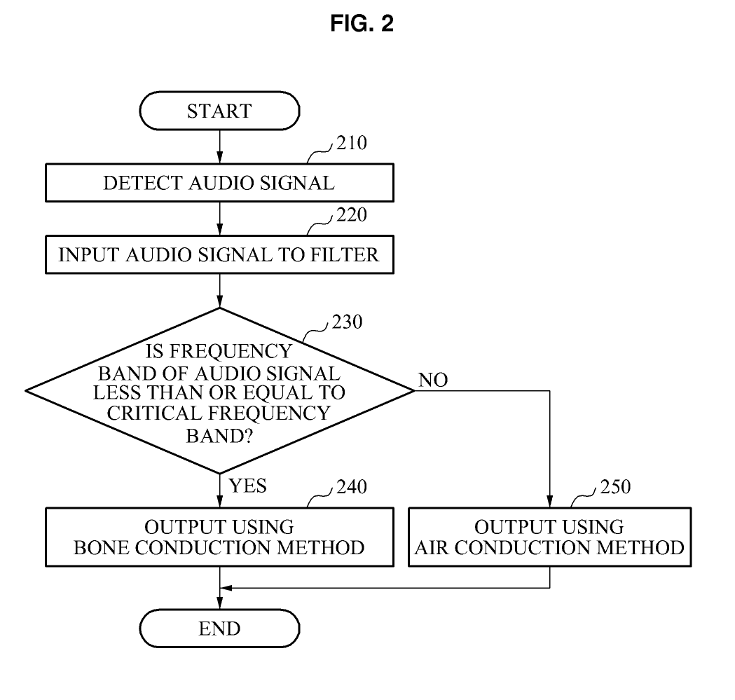

FIG. 2 is an operational flowchart illustrating an example of determining an output method. Thus, descriptions of the hybrid hearing device also apply to the operation method of FIG. 2, and will not be repeated here. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently.

Referring to FIG. 2, in 210, a hybrid hearing device may detect an audio signal. The hybrid hearing device may include at least one microphone and the hybrid hearing device may detect the audio signal using the microphone. Here, the audio signal may refer to all signals detectable from an external source through the microphone, including a voice signal.

In 220, the hybrid hearing device may input the audio signal to a filter. The filter may be a filter, such as, for example an LPF or an HPF. The LPF may allow an audio signal having a frequency band less than or equal to a critical frequency band to pass. The HPF may allow an audio signal having a frequency band greater than the critical frequency band to pass. In a non-exhaustive example, the critical frequency band may be 4000 Hz. The audio signal may be classified as the audio signal having a low frequency band and the audio signal having a high frequency band using the LPF and the HPF.

In 230, the hybrid hearing device may determine whether the frequency band of the audio signal is less than or equal to the critical frequency band. When the frequency band of the audio signal is less than or equal to the critical frequency band, in 240, the hybrid hearing device may output an output signal that is generated based on the audio signal having the low frequency band using a bone conduction method. The hybrid hearing device may output the generated output signal based on the audio signal having the low frequency band using the bone conduction method. Thus, the hybrid hearing device may maintain a low frequency response characteristic of the output signal based on the audio signal having the low frequency band. When the frequency band of the audio signal is greater than the critical frequency band, in 250, the hybrid hearing device may output an output signal that is generated based on the audio signal having the high frequency band using an air conduction method.

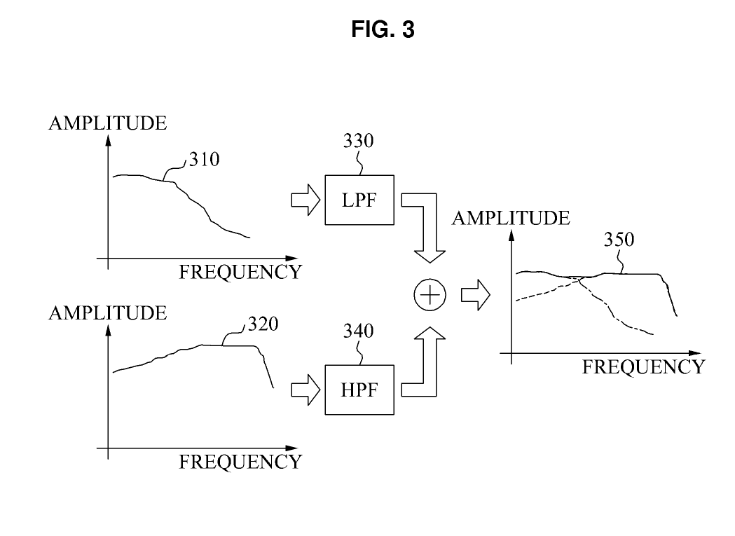

FIG. 3 is a diagram illustrating an example of a frequency characteristic of an audio signal.

Referring to FIG. 3, an audio signal 310 having a low frequency band may have a larger amplitude in the low frequency band and a smaller amplitude in a higher frequency band. Another audio signal 320 having a high frequency band may have a larger amplitude in the high frequency band and a smaller amplitude in a lower frequency band.

The hybrid hearing device may input the audio signal 310 having the low frequency band to an LPF 330. The LPF 330 may eliminate a high frequency component from the audio signal 310. The hybrid hearing device may allow the audio signal 320 having the high frequency band to pass through an HPF 340. The HPF 340 may eliminate a low frequency band component from the audio signal 320.

In a non exhaustive example, the hybrid hearing device may determine an output method to be a bone conduction method for an output signal generated based on an audio signal having passed through the LPF 330, and to be an air conduction method for an output signal generated based on an audio signal having passed through the HPF 340. The hybrid hearing device may output, using a bone conduction receiver, a low frequency band of an output signal 350 in which the output signal generated based on the audio signal having passed through the LPF 330 and the output signal generated based on the audio signal having passed through the HPF 340 are combined. The hybrid hearing device may output a high frequency band of the output signal 350 using an air conduction receiver.

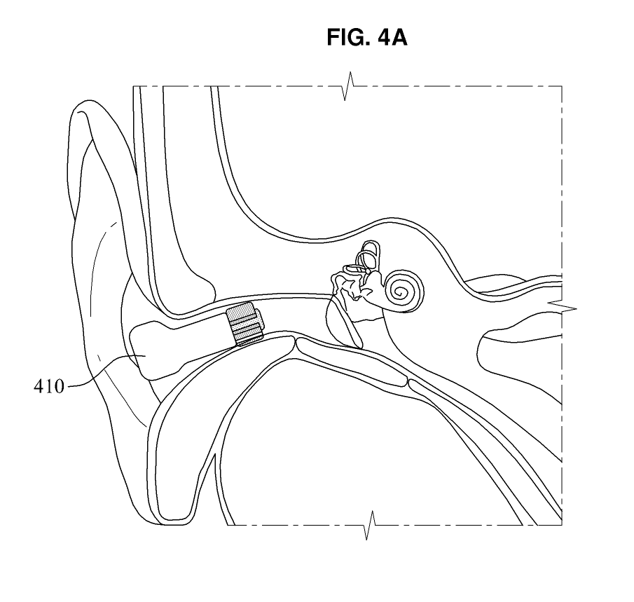

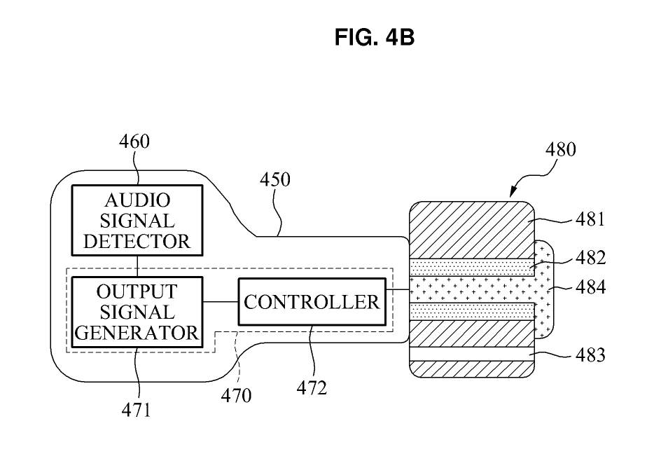

FIGS. 4A and 4B are diagrams illustrating examples of an in-ear type hybrid hearing device 410.

Referring to FIG. 4A, the in-ear type hybrid hearing device 410 may be inserted in an ear of a user. An output unit of the in-ear type hybrid hearing device 410 may include a bone conduction receiver and an air conduction receiver. When the user wears the in-ear type hybrid hearing device 410, the bone conduction receiver may be disposed around an eardrum of the user. The bone conduction receiver may output an output signal through vibrating, and the output signal may be forwarded to an auditory nerve of the user through a bone of the user.

The air conduction receiver may be disposed at the center of the bone conduction receiver. The air conduction receiver may output the output signal through air and the output signal output from the air conduction receiver may be forwarded to the auditory nerve of the user through the eardrum.

FIG. 4B is a diagram illustrating an example of the in-ear type hybrid hearing device 410 of FIG. 4A.

Referring to FIG. 4B, the in-ear type hybrid hearing device 450 may include an audio signal detector 460, an output signal generator 471, a controller 472, and an output unit 480. A processor 470 may include the output signal generator 471 and the controller 472. The in-ear type hybrid hearing device 450 may include a housing inserted in an ear of the user. The audio signal detector 460, the processor 470, and the output unit 480 may be disposed in the housing.

The audio signal detector 460 may detect an audio signal from an external source. The audio signal refers to not only a voice signal but also all signals that may be detected from the external source through at least one microphone. A frequency band of the audio signal may be in a range from about 20 Hz to about 20 kHz.

The processor 470 may convert the detected audio signal from an analog signal to a digital signal, and perform digital signal processing on the converted audio signal. The output signal generator 471 may amplify the audio signal on which the digital signal processing is performed based on an amplifying gain and generate an output signal by converting the amplified audio signal from a digital signal to an analog signal.

The controller 472 may determine an output method based on the frequency band of the audio signal. In an example, when the frequency band of the audio signal is less than or equal to a critical frequency band, the controller 472 may determine the output method to be a bone conduction method. When the frequency band of the audio signal is greater than the critical frequency band, the controller 472 may determine the output method to be an air conduction method. In this case, the critical frequency band may be 4000 Hz.

The output unit 480 may include a bone conduction receiver including an oscillator 481, a protector 482, and a vent 483. An air conduction receiver 484 may be disposed in the bone conduction receiver. The oscillator 481 may output the output signal using a bone conduction transducer. The vent 480 may vent the air present in the ear. The protector 482 may be disposed at the center of the bone conduction receiver and maintain the shape of the bone conduction receiver. The air conduction receiver 484 may be disposed in the protector 482 of the bone conduction receiver. When the user wears the in-ear type hybrid hearing device 450, the bone conduction receiver may be disposed near to the bone of the user and the air conduction receiver 484 may be disposed near to the eardrum of the user.

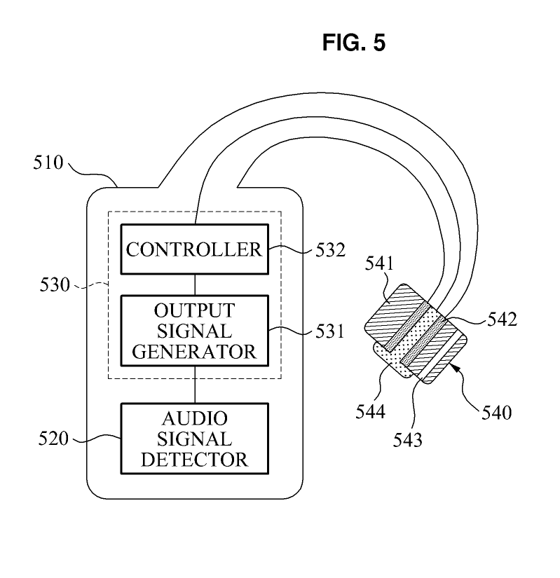

FIG. 5 is a diagram illustrating an example of a BTE type hybrid hearing device 510. Referring to FIG. 5, the BTE type hybrid hearing device 510 may include an audio signal detector 520, an output signal generator 531, a controller 532, and an output unit 540. A processor 530 may include the output signal generator 531 and the controller 532. The BTE type hybrid hearing device 510 may include a first housing disposed around an ear of a user and a second housing inserted in the ear of the user. In this case, the audio signal detector 520 and the processor 530 may be included in the first housing and the output unit 540 may be included in the second housing.

The audio signal detector 520 may detect an audio signal from an external source. The processor 530 may convert the detected audio signal from an analog signal to a digital signal and perform digital signal processing on the converted audio signal. The output signal generator 531 may generate an output signal by amplifying the audio signal on which the digital signal processing is performed and converting the amplified audio signal from a digital signal to an analog signal.

The controller 532 may determine an output method for the output signal to be one of a bone conduction method and an air conduction method based on the audio signal. When a frequency band of the audio signal is less than or equal to a critical frequency band, the controller 532 may determine the output method to be the bone conduction method. When the frequency band of the audio signal is greater than the critical frequency band, the controller 532 may determine the output method to be the air conduction method.

The output unit 540 may include a bone conduction receiver and an air conduction receiver 544. The bone conduction receiver may include an oscillator 541 to output the output signal through vibrating, a vent 542 to vent air present in the ear of the user, and a protector 543 disposed at the center of the bone conduction receiver. The air conduction receiver 544 may be disposed in the protector 543 of the bone conduction receiver.

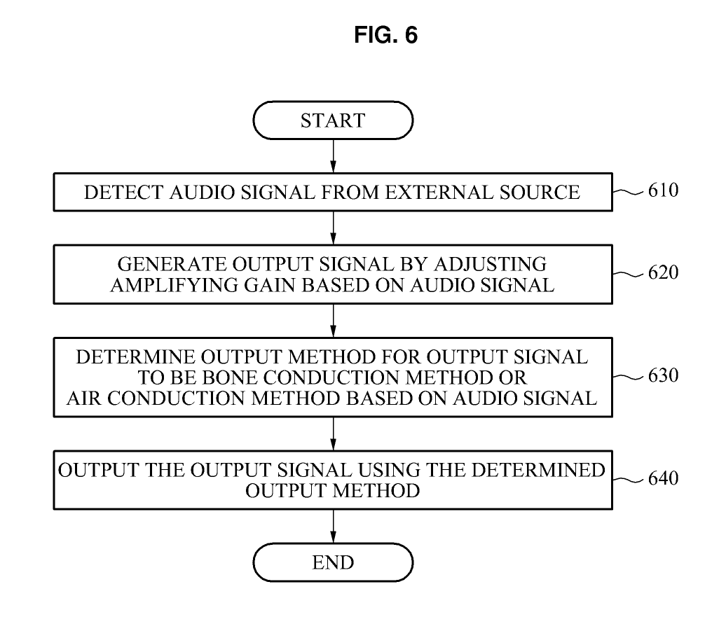

FIG. 6 is a diagram illustrating an example of an operation method of a hybrid hearing device. Thus, descriptions of the hybrid hearing device also apply to the operation method of FIG. 6, and will not be repeated here. The operations in FIG. 6 may be performed in the sequence and manner as shown, although the order of some operations may be changed or some of the operations omitted without departing from the spirit and scope of the illustrative examples described. Many of the operations shown in FIG. 6 may be performed in parallel or concurrently.

Referring to FIG. 6, in 610, the hybrid hearing device detects an audio signal.

In 620, the hybrid hearing device generates an output signal by adjusting an amplifying gain based on the audio signal.

In 630, the hybrid hearing device determines an output method for the output signal to be one of a bone conduction method and an air conduction method based on the audio signal.

In 640, the hybrid hearing device outputs the output signal using the determined output method.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

As a non-exhaustive illustration only, a terminal or device described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blue-ray player, a setup box, or any other device capable of wireless communication or network communication consistent with that disclosed herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A hearing device, comprising:
an audio signal detector configured to detect an audio signal;
an output signal generator configured to generate an output signal by adjusting an amplifying gain of the audio signal;
a controller configured to determine an output method for the output signal to be one of a bone conduction method or an air conduction method; and
an output unit configured to output the output signal.

2. The device of claim 1, wherein the controller is configured to determine the output method based on a frequency band of the audio signal.

3. The device of claim 2, wherein in response to the frequency band of the audio signal being less than or equal to a critical frequency band, the controller is configured to determine the output method to be the bone conduction method, and in response to the frequency band of the audio signal being greater than the critical frequency band, the controller is configured to determine the output method to be the air conduction method.

4. The device of claim 2, further comprising:
a low pass filter configured to allow audio signal having the frequency band less than or equal to a critical frequency band; and
a high pass filter configured to allow audio signal having the frequency band greater than the critical frequency band; and
wherein the controller is configured to determine the output method to be the bone conduction method in response to the audio signal having passed through the low pass filter, and to determine the output method to be the air conduction method in response to the audio signal having passed through the high pass filter.

5. The device of claim 1, wherein the output unit comprises:
a bone conduction receiver configured to output the output signal based on the bone conduction method; and
an air conduction receiver configured to output the output signal based on the air conduction method.

6. The device of claim 5, wherein the bone conduction receiver comprises:
an oscillator configured to output the output signal through vibrating;
a vent configured to vent air present in an ear;
a protector disposed at a center of the bone conduction receiver; and
the air conduction receiver being disposed in the protector.

7. The device of claim 1, wherein the hearing device is provided as an in-ear type hearing device, and further comprising:
a housing inserted in an ear.

8. The device of claim 1, wherein the hearing device is provided as a behind-the-ear type (BTE) hearing device, and further comprising:
a first housing disposed around an ear; and
a second housing inserted in the ear; and
wherein the output unit is disposed in the second housing.

9. The device of claim 1, wherein the amplifying gain is based on an audiogram reflecting a hearing characteristic of a user.

10. The device of claim 4, wherein the controller is configured to determine the output method to be the bone conduction method in response to the audio signal having passed through the low pass filter and the audio signal having passed through the high pass filter being combined.

11. An operation method of a hearing device, the method comprising:
detecting an audio signal;
generating an output signal by adjusting an amplifying gain of the audio signal;
determining an output method for the output signal to be one of a bone conduction method or an air conduction method; and
outputting the output signal using the determined output method.

12. The method of claim 11, wherein the determining comprises determining the output method based on a frequency band of the audio signal.

13. The method of claim 12, wherein the determining comprises:
determining the output method to be the bone conduction method in response to the frequency band of the audio signal being less than or equal to a critical frequency band; and
determining the output method to be the air conduction method in response to the frequency band of the audio signal being greater than the critical frequency band.

14. The method of claim 12, wherein the determining comprises:
determining the output method to be the bone conduction method in response to an audio signal having passed through a low pass filter, the low pass filter being configured to allow the audio signal having the frequency band less than or equal to a critical frequency band; and
determining the output method to be the air conduction method in response to an audio signal having passed through a high pass filter, the high pass filter being configured to allow the audio signal having the frequency band greater than a critical frequency band.

15. The method of claim 11, wherein the outputting comprises:
outputting the output signal using a bone conduction receiver in response to the determined output method being the bone conduction method; and
outputting the output signal using an air conduction receiver in response to the determined output method being the air conduction method.

16. The method of claim 15, wherein the bone conduction receiver comprises:
an oscillator configured to output the output signal through vibrating;
a vent configured to vent air present in an ear;
a protector disposed at a center of the bone conduction receiver; and
the air conduction receiver being disposed in the protector.

17. The method of claim 11, wherein the amplifying gain is based on an audiogram reflecting a hearing characteristic of a user wearing the hearing device.

18. A non-transitory computer-readable storage medium comprising a program to cause a computer to perform the method of claim 11.

19. A hearing device, comprising:
a housing comprising an audio signal detector, an output signal generator, a controller, and a an output unit; and
the controller is configured to determine whether to convey an output audio signal to auditory nerve via transmitting vibrations corresponding to the output audio signal to a bone or via transmitting the output audio signal through air.

20. The device of claim 19, wherein the audio signal detector is disposed at a first end of the housing and the output unit is disposed at a second end of the housing, and wherein the output unit comprises:
an oscillator disposed proximal to a bone of a user;
a vent configured to vent air present in an ear of the user;
a protector disposed near a center of the output unit; and
an air conduction receiver being disposed in the protector and proximal to the eardrum of the user.

21. The device of claim 19, wherein the output signal generator is configured to generate the output audio signal by adjusting an amplifying gain of an audio signal and the amplifying gain is based on an audiogram reflecting a hearing characteristic of a user; and the hearing device further comprises a storage configured to store the audiogram.
